(19) United States
(12) Patent Application Publication
(10) Pub. No.: US 2012/0315408 A1
(43) Pub. Date: Dec. 13, 2012

(54) INFLATABLE ARTICLE PROVIDED WITH A GASTIGHT LAYER BASED ON A BLEND OF A THERMOPLASTIC ELASTOMER AND OF A PARTIALLY CROSSLINKED BUTYL RUBBER.

(75) Inventors: Christophe Chouvel, Chamalieres (FR); Marc Greiveldinger, Chatel Guyon (FR); Emmanuel Custodero, Chamalieres (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/518,105

(22) PCT Filed: Dec. 21, 2010
(86) PCT No.: PCT/EP2010/070405

§ 371 Date: Jul. 27, 2012

(30) Foreign Application Priority Data
Dec. 23, 2009 (FR) 0959516

(51) Int. Cl. B60C 5/00

(52) U.S. Cl. 428/12

(57) ABSTRACT

An inflatable article is provided with an elastomer layer that is airtight to inflation gases used to inflate the article. The elastomer layer includes at least one blend of a thermoplastic elastomer in a proportion A and a partially crosslinked butyl rubber in a proportion B. The ratio A/B varies in a range between 1 and 20, with A and B being expressed by weight. The thermoplastic elastomer includes a polyisobutylene block.

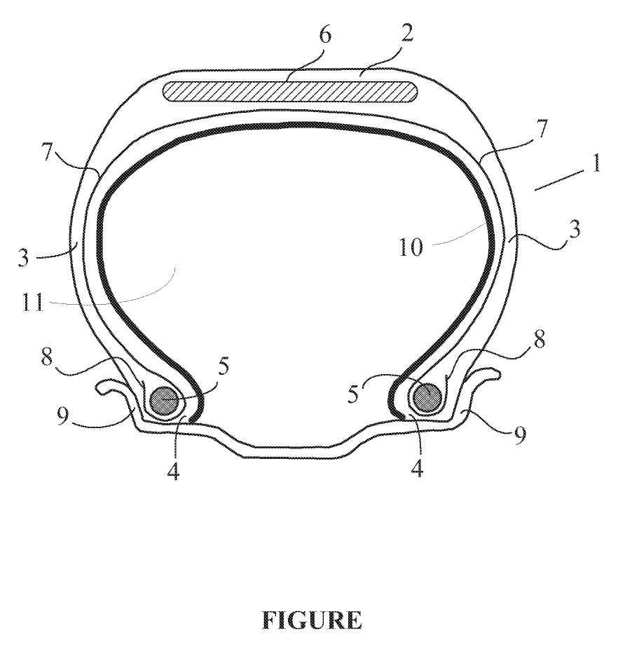

The present invention relates to “inflatable” articles, that is to say, by definition, to articles which take their usable form when they are inflated with air or with an equivalent inflation gas.

It relates more particularly to the gastight layers which ensure that these inflatable articles are airtight, in particular these for tyres.

In a conventional tyre of the tubeless type, the radially internal face comprises an airtight layer (or more generally a layer airtight to any inflation gas) which makes it possible to inflate the tyre and to keep it under pressure. Its airtightness properties allow it to guarantee a relatively low level of pressure loss, making it possible to keep the tyre inflated in a normal operating state for a sufficient period of time, normally of several weeks or several months. Another role of this layer is to protect the carcass reinforcement and more generally the remainder of the tyre from the risk of oxidation due to the diffusion of air originating from the space interior to the tyre.

This role of airtight inner liner or interior rubber is today fulfilled by compositions based on butyl rubber (copolymer of isobutylene and isoprene), which have been recognized for a very long time for their excellent airtightness properties.

However, a well-known disadvantage of the compositions based on butyl rubber or elastomer is that they exhibit high hysteresis losses, furthermore over a broad temperature spectrum, which disadvantage is damaging to the rolling resistance of the tyres.

To reduce the hysteresis of these airtight inner liners and thus, in the end, the fuel consumption of motor vehicles is a general objective which current technology comes up against.

The document WO 2008/145277 of the Applicant companies discloses an inflatable article provided with a layer airtight to the inflation gases, in which the inner liner comprises an elastomer composition comprising at least one copolymeric thermoplastic elastomer comprising polystyrene and polyisobutylene blocks and a polybutene oil.

In comparison with a butyl rubber, the thermoplastic elastomer exhibits the major advantage, due to its thermoplastic nature, of being able to be worked as is in the molten (liquid) state and consequently of offering the possibility of simplified processing.

The document EP 1 987 962 A1 provides for the use, as gastight layer, of a laminate comprising a thermoplastic elastomer layer and an adhesive layer with an unsaturated styrene block copolymer intended to reinforce adhesion between the thermoplastic elastomer layer and a layer of diene elastomer, such as a calendaring of carcass ply based on natural rubber usually used in tyres.

However, this solution is expensive industrially due to the addition of an additional layer for the preparation of a tyre.

A subject-matter of the invention is an inflatable article provided with an elastomer layer which is airtight to the inflation gases, characterized in that the said elastomer layer comprises at least one blend of a thermoplastic elastomer comprising a polyisobutylene block and of a partially crosslinked butyl rubber and in that, the thermoplastic elastomer being in a proportion A and the partially crosslinked butyl rubber being in a proportion B, the ratio A/B varies from 1 to 20; A and B being expressed by weight.

The airtight elastomer layer has very good airtightness properties and a markedly improved adhesion to a layer of diene elastomer.

The invention relates in particular to inflatable articles made of rubber, such as tyres, or inner tubes, in particular inner tubes for tyres.

The invention relates more particularly to the tyres intended to equip motor vehicles of the following types: passenger vehicles, SUVs (Sports Utility Vehicles), two-wheel vehicles (in particular motorcycles), aircraft, such as industrial vehicles chosen from vans, heavy-duty vehicles—that is to say, underground, bus, heavy road transport vehicles (lorries, tractors, trailers) or off-road vehicles, such as agricultural vehicles or earth-moving equipment—or other transportation or handling vehicles.

The invention and its advantages will be easily understood in the light of the description and implementation examples which follow and also from the single FIGURE relating to these examples, which gives a diagrammatic representation, in radial cross section, of a tyre in accordance with the invention.

### I. DETAILED DESCRIPTION OF THE INVENTION

In the present description, unless expressly indicated otherwise, all the percentages (%) shown are % by weight.

Furthermore, any range of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### I-1. Gastight Elastomer Composition

The inflatable article according to the invention has the essential characteristic of being provided with an elastomer layer which is airtight to the inflation gases, comprising at least one blend of a thermoplastic elastomer comprising a polyisobutylene block and of a partially crosslinked butyl rubber and such that, the thermoplastic elastomer being in a proportion A and the partially crosslinked butyl rubber being in a proportion B, the ratio A/B varies from 1 to 20; A and B being expressed by weight.

Preferably, this ratio A/B varies from 1 to 5.

The increase in the content of partially crosslinked butyl rubber in the airtight elastomer layer when the ratio A/B changes from 20 to 5 is reflected by an improvement in the adhesion of the airtight elastomer layer to the adjacent blends.

Below a ratio A/B of 1, the processing of the airtight elastomer composition with means suitable for thermoplastic materials becomes more difficult.

### I-1-A. Thermoplastic Elastomer Comprising a Polyisobutylene Block

Thermoplastic elastomers have a structure immediately between thermoplastic polymers and elastomers. They are composed of rigid thermoplastic blocks connected via flexible elastomer blocks, for example polybutadiene, polyisoprene, poly(ethylene/butylene) or polyisobutylene. They are often triblock elastomers with two rigid segments connected via a flexible segment. The rigid and flexible segments can be positioned linearly, in star fashion or in branched fashion. Typically, each of these segments or blocks comprises at least more than 5, generally more than 10, base units (for example, styrene units and isoprene units for a styrene/isoprene/styrene block copolymer).

Preferably, the thermoplastic elastomer comprising a polyisobutylene block (hereinafter abbreviated to “TPEI”), according to one subject-matter of the invention, comprises, at least one of the ends of the polyisobutylene block, a thermoplastic block having a glass transition temperature of greater than or equal to 100° C.

The number-average molecular weight (denoted Mn) of the thermoplastic elastomer comprising a polyisobutylene block is preferably between 30 000 and 500 000 g/mol, more preferably between 40 000 and 400 000 g/mol. Below the minima indicated, there is a risk of the cohesion between the chains of the TPEI being affected, in particular due to its possible dilution (in the presence of an extending oil); moreover, an increase in the operating temperature risks affecting the mechanical properties, in particular the breaking properties, with a consequence of a reduced performance “under hot conditions”. Furthermore, an excessively high weight Mn can be damaging with regard to the flexibility of the gastight layer. Thus, it has been found that a value within a range from 50 000 to 300 000 g/mol is particularly well suited, in particular to use of the thermoplastic elastomer comprising a polyisobutylene block or TPEI in a tyre composition.

The number-average molecular weight (Mn) of the TPEI is determined in a known way by steric exclusion chromatography (SEC). The sample is dissolved beforehand in tetrahydrofuran at a concentration of approximately 1 g/l; the solution is then filtered through a filter with a porosity of 0.45 μm before injection. The equipment used is a “Waters alliance” chromatographic line. The elution solvent is tetrahydrofuran, the flow rate is 0.7 ml/min, the temperature of the system is 35° C. and the analytical time is 90 min. A set of four Waters columns in series, with the “Styragel” trade names (“HMW7”, “HMW6E” and two “HT6E”), is used. The injected volume of the solution of the polymer sample is 100 μl. The detector is a “Waters 2410” differential refractometer and its associated software for making use of the chromatographic data is the “Waters Millennium” system. The calculated average molar masses are relative to a calibration curve produced with polystyrene standards.

The polydispersity index PI (it should be remembered that PI=Mw/Mn, with Mw the weight-average molecular weight) of the TPEI is preferably less than 3; more preferably PI is less than 2 and more preferably still less than 1.5.

The elastomeric block is composed predominantly of the polymerized isobutylene monomer. Preferably, the polyisobutylene block of the block copolymer exhibits a number-average molecular weight (“Mn”) ranging from 25 000 g/mol to 350 000 g/mol, preferably from 35 000 g/mol to 250 000 g/mol, so as to confer, on the thermoplastic elastomer, good elastomeric properties and a mechanical strength which is sufficient and comparable with the inner liner application of a tyre.

Preferably, the polyisobutylene block of the block copolymer additionally exhibits a glass transition temperature (“Tg”) of less than or equal to −20° C., more preferably of less than −40° C. A Tg value greater than these minima may reduce the performance of the airtight layer during use at very low temperature; for such a use, the Tg of the polyisobutylene block of the block copolymer is more preferably still less than −50° C.

The polyisobutylene block of the TPEI can also advantageously comprise a content of units resulting from one or more conjugated dienes inserted into the polymer chain preferably ranging up to 16% by weight, with respect to the weight of the polyisobutylene block. Above 16%, a fall in the resistance to thermal oxidation and the oxidation by ozone may be observed for the airtight layer comprising the thermoplastic elastomer comprising a polyisobutylene block used in a tyre.

The conjugated dienes which can be copolymerized with the isobutylene in order to form the polyisobutylene block are conjugated C₄-C₁₄ dienes. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene, and mixtures thereof. More preferably, the conjugated diene is isoprene or a mixture comprising isoprene.

The polyisobutylene block, according to an advantageous aspect of the subject-matter of the invention, can be halogenated and can comprise halogen atoms in its chain. This halogenation makes it possible to increase the rate of curing of the composition comprising the thermoplastic elastomer having a polyisobutylene block according to the invention. This halogenation makes it possible to improve the compatibility of the airtight layer with the other adjacent constituent components of a tyre. Halogenation is carried out by means of bromine or chlorine, preferably bromine, on the units resulting from conjugated dienes of the polymer chain of the polyisobutylene block. Only a portion of these units reacts with the halogen.

According to a first embodiment, the TPEI is chosen from styrene thermoplastic elastomers having a polyisobutylene block (“TPSI”).

The thermoplastic block is thus composed of at least one polymerized monomer based on unsubstituted as substituted styrene; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or para-hydroxystyrene.

Preferably, the thermoplastic elastomer TPSI is a polystyrene and polyisobutylene block copolymer.

Preferably, such a block copolymer is a styrene/isobutylene diblock copolymer (abbreviated to “SIB”).

More preferably still, such a block copolymer is a styrene/isobutylene/styrene triblock copolymer (abbreviated to “SIBS”).

According to a preferred embodiment of the invention, the content by weight of styrene (unsubstituted or substituted) in the styrene elastomer is between 5 and 50%. Below the minimum indicated, the thermoplastic nature of the elastomer risks being substantially reduced, whereas, above the recommended maximum, the elasticity of the airtight layer may be affected. For these reasons, the styrene content is more preferably between 10 and 40%, in particular between 15 and 35%.

The TPSI elastomer, optionally extended with a polybutene oil, is preferably the only constituent thermoplastic elastomer of the gastight elastomer layer.

The TPSI elastomers can be processed conventionally, by extrusion or moulding, for example starting from a starting material available in the form of beads or granules.

The TPSI elastomers are available commercially, for example sold, as regards the SIB and SIBS, by Kaneka under the name “Sibstar” (e.g. “Sibstar 103T”, “Sibstar 102T”, “Sibstar 073T” or “Sibstar 072T” for the SIBSs or “Sibstar 042D” for the SIBs). They have, for example, been described, along with their synthesis, in the patent documents EP 731 112, U.S. Pat. No. 4,946,899 and U.S. Pat. No. 5,260,383. They have been developed first of all for biomedical applications and then described in various applications specific to TPSI elastomers, as varied as medical equipment, motor vehicle or domestic electrical appliance parts, sheathings for electric wires, or airtight or elastic parts (see, for example, EP 1 431 343, EP 1 561 783, EP 1 566 405 and WO 2005/103146).

According to a second embodiment, the TPEI elastomers can also comprise a thermoplastic block having a Tg of greater than or equal to 100° C. and formed from polymerized monomers other than styrene monomers (abbreviated to “TPNSI”). Such monomers can be chosen from the following compounds and their mixtures:
acenaphthylene: a person skilled in the art may, for example, refer to the paper by Z. Fodor and J. P. Kennedy, Polymer Bulletin, 1992, 29(6), 697-705;
indene and its derivatives, such as, for example, 2-methylindene, 3-methylindene, 4-methylindene, dimethylindenes, 2-phenylindene, 3-phenylindene and 4-phenylindene; a person skilled in the art may, for example, refer to the patent document U.S. Pat. No. 4,946,899 by the inventors Kennedy, Puskas, Kaszas and Hager and to the documents J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;
isoprene, then resulting in the formation of a number of trans-1,4-polyisoprene units and of units cyclized according to an intramolecular process; a person skilled in the art may, for example, refer to the documents G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80;
esters of acrylic acid, crotonic acid, sorbic acid or methacrylic acid, derivatives of acrylamide, derivatives of methacrylamide, derivatives of acrylonitrile, derivatives of methacrylonitrile and their mixtures. Mention may more particularly be made of adamantyl acrylate, adamantyl crotonate, adamantyl sorbate, 4-biphenylyl acrylate, tert-butyl acrylate, cyanomethyl acrylate, 2-cyanoethyl acrylate, 2-cyanobutyl acrylate, 2-cyanohexyl acrylate, 2-cyanoheptyl acrylate, 3,5-dimethyladamantyl acrylate, 3,5-dimethyladamantyl crotonate, isobornyl acrylate, pentachlorobenzyl acrylate, pentafluorobenzyl acrylate, pentachlorophenyl acrylate, pentafluorophenyl acrylate, adamantyl methacrylate, 4-(tert-butyl)cyclohexyl methacrylate, tert-butyl methacrylate, 4-(tert-butyl)phenyl methacrylate, 4-cyanophenyl methacrylate, 4-cyanomethylphenyl methacrylate, cyclohexyl methacrylate, 3,5-dimethyladamantyl methacrylate, dimethylaminoethyl methacrylate, 3,3-dimethylbutyl methacrylate, methacrylic acid, methyl methacrylate, ethyl methacrylate, phenyl methacrylate, isobornyl methacrylate, tetradecyl methacrylate, trimethylsilyl methacrylate, 2,3-xylenyl methacrylate, 2,6-xylenyl methacrylate, acrylamide, N-(sec-butyl)acrylamide, N-(tert-butyl)acrylamide, N,N-diisopropylacrylamide, N-(1-methylbutyl)acrylamide, N-methyl-N-phenyl-acrylamide, morpholinylacrylamide, piperidylacrylamide, N-(tert-butyl)meth-acrylamide, 4-butoxycarbonylphenylmethacrylamide, 4-carboxyphenylmethacrylamide, 4-methoxycarbonylphenylmethacrylamide, 4-ethoxycarbonylphenylmethacrylamide, butyl cyanoacrylate, methyl chloroacrylate, ethyl chloroacrylate, isopropyl chloroacrylate, isobutyl chloroacrylate, cyclohexyl chloroacrylate, methyl fluoromethacrylate, methyl phenylacrylate, acrylonitrile, methacrylonitrile, and mixtures thereof.

According to one alternative form, the polymerized monomer other than a styrene monomer can be copolymerized with at least one other monomer so as to form a thermoplastic block having a Tg of greater than or equal to 100° C. According to this aspect, the molar fraction of the polymerized monomer other than a styrene monomer, with respect to the total number of units of the thermoplastic block, must be sufficient to achieve a Tg of greater than or equal to 100° C., preferably of greater than or equal to 130° C., more preferably still of greater than or equal to 150° C., indeed even of greater than or equal to 200° C. Advantageously, the molar fraction of this other comonomer can range from 0 to 90%, more preferably from 0 to 75% and more preferably still from 0 to 50%.

By way of illustration, this other monomer capable of copolymerizing with the polymerized monomer other than a styrene monomer can be chosen from diene monomers, more particularly conjugated diene monomers having from 4 to 14 carbon atoms, and monomers of vinylaromatic type having from 8 to 20 carbon atoms.

When the comonomer is a conjugated diene having from 4 to 14 carbon atoms, it advantageously represents a molar fraction, with respect to the total number of units of the thermoplastic polymer, ranging from 0 to 25%. Suitable as conjugated dienes which can be used in the thermoplastic blocks according to a subject-matter of the invention are those described above, namely isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixtures.

When the comonomer is of vinylaromatic type, it advantageously represents a fraction of units, with regard to the total number of units of the thermoplastic block, from 0 to 90%, preferably ranging from 0 to 75% and more preferably still ranging from 0 to 50%. Suitable in particular as vinylaromatic compounds are the abovementioned styrene monomers, namely methylstyrenes, para-(tert-butyl)styrene, chlorostyrenes, bromostyrenes, fluorostyrenes or para-hydroxystyrene. Preferably, the comonomer of vinylaromatic type is styrene.

Mention may be made, as illustrative but nonlimiting examples, of mixtures of comonomers, which can be used for the preparation of thermoplastic blocks having a Tg of greater than or equal to 100° C., composed of indene and of styrene derivatives, in particular para-methylstyrene or para-(tert-butyl)styrene. A person skilled in the art may then refer to the documents J. E. Puskas, G. Kaszas, J. P. Kennedy and W. G. Hager, Journal of Polymer Science, Part A: Polymer Chemistry, 1992, 30, 41, or J. P. Kennedy, S. Midha and to Y. Tsungae, Macromolecules (1993), 26, 429.

Preferably, a TPNSI thermoplastic elastomer is a diblock copolymer: thermoplastic block/isobutylene block. More preferably still, such a TPNSI thermoplastic elastomer is a triblock copolymer: thermoplastic block/isobutylene block/thermoplastic block.

### I-1-B. Partially Crosslinked Butyl Rubber

The term butyl rubber is normally understood to mean a homopolymer of isobutylene or a copolymer of isobutylene with isoprene (this butyl rubber is included among the diene elastomers), and the halogenated derivatives, in particular generally brominated or chlorinated derivatives, of these homopolymers and copolymers of isobutylene and isoprene.

Mention will be made, as examples of butyl rubber, of copolymers of isobutylene and isoprene (IIR), bromobutyl rubbers, such as the bromoisobutylene/isoprene copolymer (BIIR) and chlorobutyl rubbers, such as the chloroisobutylene/isoprene copolymer (CIIR).

By extension of the preceding definition, the term “butyl rubber” will also include copolymers of isobutylene and styrene derivatives, such as brominated isobutylene methylstyrene copolymers (BIMSs), included among which is in particular the “Exxpro” elastomer sold by Exxon.

Suitable in particular for the implementation of the invention are butyl rubbers as described above which are partially crosslinked.

The partial crosslinking of the butyl rubber can be carried out by any means which makes it possible to establish covalent bonds between the butyl rubber chains; mention may be made, by way of example, of the use of free radical generators, of vulcanization agents, and the like. The partial crosslinking is reflected by a significant increase in the molecular weight, which must nevertheless be limited in order for the butyl rubber to remain compatible, i.e. soluble in the composition. Preferably, the polydispersity index PI of the partially crosslinked butyl rubber is greater than 4. Preferably, the weight-average molecular weight of the partially crosslinked butyl is greater than 500 000 g/mol and very preferably greater than 1 000 000 g/mol.

Mention may be made, by way of example, of “Kalar 5210” from Royal Elastomer. This partially crosslinked butyl is supplied in the form of pellets, which facilitates the introduction thereof into a formulation based on a TPEI elastomer without substantially modifying the procedure.

This material exhibits a PI of 5.1 and a weight-average molecular weight Mw of 1 096 000 g/mol.

### I-1-C. Extending Oil

The two preceding elastomers are sufficient by themselves alone to fulfil the functions of gastightness and of adhesion to the adjacent rubber layers with regard to the inflatable articles in which they are used.

However, according to a preferred embodiment of the invention, the elastomer composition described above also comprises, as plasticizing agent, an extending oil (or plasticizing oil), the role of which is to facilitate the processing of the gastight layer, particularly its incorporation in the inflatable article, by a lowering of the modulus and an increase in the tackifying power.

Use may be made of any extending oil, preferably having a weakly polar nature, capable of extending or plasticizing elastomers, in particular thermoplastic elastomers. At ambient temperature (23° C.), these oils, which are more or less viscous, are liquids (that is to say, to recapitulate, substances having the ability to eventually assume the shape of their container), in contrast in particular to resins or rubbers, which are solids by nature.

Preferably, the extending oil is chosen from the group consisting of polyolefin oils (that is to say, resulting from the polymerization of olefins, monoolefins or diolefins), paraffinic oils, naphthenic oils (of low or high viscosity), aromatic oils, mineral oils and mixtures of these oils.

While it has been found that the addition of oil admittedly takes place at the cost of a certain loss in airtightness, which can vary according to the type of the amount of oil used, this loss in airtightness can be largely mitigated in particular by the addition of a platy filler.

Use is preferably made of an oil of polybutene type, in particular a polyisobutylene oil (abbreviated to “PIB”), which has demonstrated the best compromise in properties in comparison with the other oils tested, in particular with a conventional oil of the paraffinic type.

By way of examples, polyisobutylene oils are sold in particular by Univar under the name “Dynapak Poly” (e.g., “Dynapak Poly 190”), by Ineos Oligomer under the name “Indopol H1200” or by BASF under the names “Glissopal” (e.g., “Glissopal 1000”) and “Oppanol” (e.g., “Oppanol B12”); paraffinic oils are sold, for example, by Exxon under the name “Telura 618” or by Repsol under the name “Extensol 51”.

The number-average molecular weight (Mn) of the extending oil is preferably between 200 and 25000 g/mol and more preferably still between 300 and 10 000 g/mol. For excessively low weights Mn, there exists a risk of migration of the oil outside the composition, whereas excessively high weights can result in excessive stiffening of this composition. A weight Mn of between 350 and 4000 g/mol, in particular between 400 and 3000 g/mol, has proved to constitute an excellent compromise for the target applications, in particular for use in a tyre.

The number-average molecular weight (Mn) of the extending oil is determined by SEC, the sample being dissolved beforehand in tetrahydrofuran at a concentration of approximately 1 g/l; the solution is then filtered through a filter with a porosity of 0.45 μm before injection. The equipment is the “Waters Alliance” chromatographic line. The elution solvent is tetrahydrofuran, the flow rate is 1 ml/min, the temperature of the system is 35° C. and the analytic time is 30 min. Use is made of a set of two “Waters” columns bearing the name “Styragel HT6E”. The injected volume of the solution of the polymer sample is 100 μl. The detector is a “Waters 2410” differential refractometer and its associated software for making use of the chromatographic data is the “Waters Millenium” system. The calculated average molar masses are relative to a calibration curve produced with polystyrene standards.

A person skilled in the art will be able, in the light of the description and implementational examples which follow, to adjust the amount of extending oil as a function of the specific conditions of use of the gastight elastomer layer, in particular of the inflatable article in which it is intended to be used.

It is preferable for the content of extending oil to be lower than 5 phr, preferably between 5 and 150 phr (parts by weight per hundred parts of total elastomer, that is to say block TPEI elastomers, such as SIBS, plus partially crosslinked butyl rubber, present in the elastomer composition or layer).

Below the minimum indicated, the presence of extending oil is not noticeable. Above the recommended maximum, the risk is encountered of insufficient cohesion of the composition and of loss in airtightness which may be harmful depending on the application under consideration.

For these reasons, in particular for use of the airtight composition in a tyre, it is preferable for the content of extending oil to be greater than 10 phr, in particular between 10 and 130 phr, more preferably still for it to be greater than 20 phr, in particular between 20 and 100 phr.

### I-1-D. Platy Filler

The use of platy filler advantageously makes it possible to lower the coefficient of permeability (and thus to increase the airtightness) of the elastomer composition without excessively increasing its modulus, which makes it possible to retain the ease of incorporation of the airtight layer in the inflatable article.

“Platy” fillers are well known to a person skilled in the art. They have been used in particular in tyres to reduce the permeability of conventional gastight layers based on butyl rubber. They are generally used in these butyl-based layers at relatively low contents not exceeding generally from 10 to 15 phr (see, for example, the patent documents US 2004/0194863 and WO 2006/047509).

They are generally provided in the form of stacked plates, platelets, sheets or lamellae, with a more or less marked anisometry. Their aspect ratio (A=L/T) is generally greater than 3, more often greater than 5 or than 10, L representing the length (or greatest dimension) and T representing the mean thickness of these platy fillers, these means being calculated on a number basis. Aspect ratios reaching several tens, indeed even several hundreds, are frequent. Their mean length is preferably greater than 1 μm (that is to say that “micrometric” platy fillers are then involved), typically between several μm (for example 5 μm) and several hundred μm (for example 500 μm, indeed even 800 μm).

Preferably, the platy fillers used in accordance with the invention are chosen from the group consisting of graphites, phyllosilicates and the mixtures of such fillers. Mention will in particular be made, among phyllosilicates, of clays, talcs, micas or kaolins, it being possible for these phyllosilicates to be or not to be modified, for example by a surface treatment; mention may in particular be made, as examples of such modified phyllosilicates, of micas covered with titanium oxide or clays modified by surfactants (“organo clays”).

Use is preferably made of platy fillers having a low surface energy, that is to say which are relatively nonpolar, such as those chosen from the group consisting of graphites, talcs, micas and the mixtures of such fillers, it being possible for the latter to be or not to be modified, more preferably still from the group consisting of graphites, talcs and the mixtures of such fillers. Mention may in particular be made, among graphites, of natural graphites, expanded graphites or synthetic graphites.

Mention may be made, as examples of micas, of the micas sold by CMMP (Mica-MU®, Mica-Soft® and Briomica®, for example), the micas sold by Yamaguchi (A51S, A41S, SYA-21R, SYA-21RS, A21S and SYA-41R), vermiculites (in particular the vermiculite Shawatec® sold by CMMP or the vermiculite Microlite® sold by W.R. Grace) or modified or treated micas (for example, the Iriodin® range sold by Merck). Mention may be made, as examples of graphites, of the graphites sold by Timcal (Timrex® range). Mention may be made, as examples of talcs, of the talcs sold by Luzenac.

The platy fillers described above can be used at variable contents, in particular between 2 and 30% by volume of elastomer composition and preferably between 3 and 20% by volume.

The introduction of the platy fillers into the thermoplastic elastomer composition can be carried out according to various known processes, for example by solution mixing, by bulk mixing in an internal mixer or by extrusion mixing.

### I-1-E. Various Additives

The airtight layer or composition described above can furthermore comprise the various additives normally present in the airtight layers known to a person skilled in the art. Mention will be made, for example, of reinforcing fillers, such as carbon black or silica, non-reinforcing or inert fillers other than the platy fillers described above, colouring agents which can advantageously be used for the colouring of the composition, plasticizers other than the abovementioned extending oils, tackifying resins, protecting agents, such as antioxidants or antiozonants, UV stabilizers, various processing aids or other stabilizing agents, or promoters capable of promoting the adhesion of the inflatable article to the remainder of the structure.

In addition to the abovementioned elastomers (TPEI, TPSI, TPNSI, partially crosslinked butyl rubber), the gastight composition might also comprise, always according to a minor fraction by weight with respect to the block elastomer, polymers other than elastomers, such as, for example, thermoplastic polymers.

### I-2. Use of the Airtight Layer in a Tyre

The airtight layer based on TPEI elastomer described above can be used as airtight layer in any type of inflatable article. Mention may be made, as examples of such inflatable articles, of inflatable boats, or balloons or balls used for play or sport.

It is particularly well suited to use as airtight layer (or layer airtight to any other inflation gas, for example nitrogen) in an inflatable article, finished product or semi-finished product made of rubber, very particularly in a tyre for a motor vehicle, such as a vehicle of two-wheel, passenger or industrial type.

Such an airtight layer is preferably positioned on the internal wall of the inflatable article but it can also be fully incorporated in its internal structure.

The thickness of the airtight layer is preferably greater than 0.05 mm, more preferably between 0.1 mm and 10 mm (in particular between 0.1 and 1.0 mm).

It will be easily understood that, depending on the specific fields of application, the dimensions and the pressures at work, the embodiment of the invention can vary, the airtight layer then comprising several preferred ranges of thickness.

Thus, for example, for tyres of passenger vehicle type, it can have a thickness of at least 0.05 mm, preferably of between 0.1 and 2 mm. According to another example, for tyres for heavy-duty or agricultural vehicles, the preferred thickness can be between 1 and 3 mm. According to another example, for tyres for vehicles in the civil engineering field or for aircraft, the preferred thickness can be between 2 and 10 mm.

In comparison with an airtight layer as disclosed in the document WO 2008/145277 A1, the airtight layer according to the invention has the advantage of having a markedly improved adhesion to the adjacent diene layer while retaining an airtightness to gases which is at least equal, as is demonstrated in the following implementation of examples.

### II. EXAMPLES OF THE IMPLEMENTATION OF THE INVENTION

The gastight layer described above can advantageously be used in tyres for all types of vehicles, in particular passenger vehicles or industrial vehicles, such as heavy-duty vehicles.

By way of example, the single appended FIGURE represents, highly diagrammatically (without observing a specific scale), a radial cross section of a tyre in accordance with the invention.

This tyre 1 comprises a crown 2 reinforced by a crown reinforcement or belt 6, two sidewalls 3 and two beads 4, each of these beads 4 being reinforced with a bead thread 5. The crown 2 is surmounted by a tread not represented in this diagrammatic FIGURE. A carcass reinforcement 7 is wound around the two bead threads 5 in each bead 4, the turn-up 8 of this reinforcement 7 being, for example, positioned towards the outside of the tyre 1, which is here represented fitted to its wheel rim 9. The carcass reinforcement 7 is, in a way known per se, composed of at least one ply reinforced by “radial” cables, for example textile or metal cables, that is to say that these cables are positioned virtually parallel to one another and extend from one bead to the other, so as to form an angle of between 80° and 90° with the median circumferential plane (plane perpendicular to the axis of rotation of the tyre which is situated at mid-distance from the two beads 4 and passes through the middle of the crown reinforcement 6).

The internal wall of the tyre 1 comprises an airtight layer 10, for example with a thickness equal to approximately 0.9 mm, from the side of the internal cavity 11 of the tyre 1.

This inner liner covers the whole of the internal wall of the tyre, extending from one sidewall to the other, at least up to the level of the rim flange when the tyre is in the fitted position. It defines the radially internal face of the said tyre intended to protect the carcass reinforcement from the diffusion of air originating from the space 11 interior to the tyre. It makes possible the inflation and the maintenance under pressure of the tyre; its airtightness properties must allow it to guarantee a relatively low degree of loss in pressure and to keep the tyre inflated, in the normal operating state, for a sufficient period of time, normally of several weeks or several months.

In contrast to a conventional tyre using a composition based on butyl rubber, the tyre in accordance with the invention uses, in this example, as airtight layer 10, an elastomer composition comprising an SIBS elastomer (“Sibstar 102T” with a styrene content of approximately 15%, a Tg of approximately −65° C. and an Mn of approximately 90 000 g/mol), and a partially crosslinked butyl rubber (“Kalar 5210®”, sold by Royal Elastomer) extended with a PIB oil (for example, the oil “Indopol H1200”—Mn of the order of 2100 g/mol), and also a platy filler (“SYA41R” from Yamaguchi).

A layer (skim) of the gastight layer can be produced in particular with the device described in the document EP 2 072 219 A1. This device comprises an extrusion tool, such as a twin-screw extruder, a die, a liquid cooling bath and a movable level support.

The tyre provided with its airtight layer 10 as described above is preferably produced before vulcanization (or curing).

The airtight layer is simply applied conventionally to the desired spot for formation of the layer 10. Vulcanization is subsequently carried out conventionally. The block elastomers withstand well the stresses related to the vulcanization stage.

An advantageous alternative form of manufacture for a person skilled in the art of tyres will consist, for example, during the first stage, in depositing, flat, the airtight layer directly on a building drum, in the form of a layer (skim) of suitable thickness, before covering the latter with the remainder of the structure of the tyre, according to manufacturing techniques well known to a person skilled in the art.

### II-1. Tests

The properties of the gastight elastomer compositions and of some of their constituents are characterized as indicated below.

A Airtight Layer/Diene Layer Adhesion Tests

Adhesion tests (peel tests) were carried out in order to test the ability of the gastight layer to adhere, after curing, to a diene elastomer layer, more specifically to a standard rubber composition for a tyre carcass reinforcement, based on natural (peptise) rubber and on carbon black N330 (65 parts by weight per hundred parts of natural rubber), additionally comprising the normal additives (sulphur, accelerator, ZnO, stearic acid, antioxidant).

The peeling test specimens (of the 180° peeling type) were produced by stacking a thin layer of gastight composition between two calendered fabrics, the first with an SIBS elastomer (1.5 mm) and another with the diene blend under consideration (1.2 mm). An incipient crack is inserted between the two calendared fabrics at the end of the thin layer.

The test specimen, after assembly, was vulcanized at 180° C. under pressure for 10 minutes. Strips with a width of 30 mm were cut out using a cutting machine. The two sides of the incipient crack were subsequently placed in the jaws of a tensile testing device with the Intron® trade name. The tests are carried out at ambient temperature and at a pull rate of 100 mm/min. The tensile stresses are recorded and the latter are standardized by the width of the test specimen. A curve of strength per unit of width (in N/mm) as a function of the movable crossrail displacement of the tensile testing device (between 0 and 200 mm) is obtained. The adhesion value selected corresponds to the initiation of failure in the test specimen and thus to the maximum value of this curve.

B Cohesion Test

Similar peel tests were carried out in order to test the cohesion of the TPEI-based airtight compositions.

The cohesion test specimens (of the 180° peeling type) were produced by stacking a thin layer of gastight composition between two calendered fabrics with an SIBS elastomer (1.5 mm). An incipient crack is inserted between the two calendared fabrics at the end of the thin layer.

The test specimen, after assembly, was vulcanized at 180° C. under pressure for 10 minutes. Strips with a width of 30 mm were cut out with a cutting machine. The two sides of the incipient crack were subsequently placed in the jaws of a tensile testing device with the Intron® trade name. The tests are carried out at ambient temperature and at a pull rate of 100 mm/min. The tensile stresses are recorded and the latter are standardized by the width of the test specimen. The curve of strength per unit of width (in N/mm) as a function of the movable crossrail displacement of the tensile testing device (between 0 and 200 mm) is obtained. The cohesion value selected corresponds to the initiation of failure in the test specimen and thus to the maximum value of this curve.

C Airtightness Tests

Use was made, for this analysis, of a rigid wall permeameter, placed in an oven (temperature at 60° C. in the present case), equipped with a relative pressure sensor (calibrated in the range from 0 to 6 bar) and connected to a tube equipped with an inflation valve. The permeameter can receive standard test specimens in the disk form (for example, with a diameter of 65 mm in the present case) and with a uniform thickness which can range up to 1.5 mm (0.5 mm in the present case). The pressure sensor is connected to a National Instruments data acquisition card (0-10 V analogue four-channel acquisition) which is connected to a computer carrying out continuous acquisition with a frequency of 0.5 Hz (1 point every two seconds). The permeability coefficient (K) is measured from the linear regression line giving the slope a of the loss in pressure through the tested test specimen as a function of the time, after stabilization of the system, that is to say the achievement of stable conditions under which the pressure decreases linearly as a function of the time.

### II-2. Tests

Gastight compositions comprising an SIBS elastomer (“Sibstar 102T” from Kaneka), a PIB oil (“Indopol H1200” from INEOS Oligomer) and a platy filler (“SYA41R” from Yamaguchi) were prepared using the device of the document EP 2 072 219 A1. The reference composition C-1 comprises only SIBS as elastomer. The composition C-2 comprises a blend of SIBS and SIS (“Kraton D1161” from Kraton) in an A/B ratio equal to 4. The composition C-3 comprises a blend of SIBS and a partially crosslinked butyl rubber (“Kalar 5210” from Royal Elastomer), also in an A/B ratio equal to 4. The composition C-4 comprises a blend of SIBS and the same partially crosslinked butyl rubber in an A/B ratio equal to 1.

Airtightness, adhesion and cohesion tests as described above were carried out in these compositions. All the compositions and the adhesion, cohesion and airtightness results are presented in Table 1. Composition C-1 is taken as reference.

TABLE 1

| | Composition No.: | C-1 | C-2 | C-3 | C-4 |
|---|---|---|---|---|---|
| A | SIBS—Sibstar 102 T—Kaneka | 100% | 80% | 80% | 50% |
| | (phr) | | | | |
| B | Kalar 5210—Royal Elastomer | | | 20% | 50% |
| | (phr) | | | | |
| | SIS D1161—Kraton (phr) | | 20% | | |
| | A/B | | | 4 | 1 |
| | PIB oil Indopol H1200—Ineos | 67 | 67 | 67 | 67 |
| | Oligomer (phr) | | | | |
| | Mica—SYA 41 R—Yamaguchi | 10% | 10% | 10% | 10% |
| | (% by volume) | | | | |
| | Relative airtightness (%) | 100 | 59 | 75 | 82 |
| | Relative adhesion (%) | 100 | 910 | 455 | 935 |
| | Relative cohesion (%) | 100 | 44 | 68 | 68 |

Composition C-2, comprising a blend of SIBS and SIS with an A/B ratio of 4, exhibits an excellent relative adhesion but the cohesion results are very poor.
Composition C-3, in accordance with a subject-matter of the invention, comprises a blend of SIBS and partially crosslinked butyl rubber with the same A/B ratio of 4. The presence of partially crosslinked butyl rubber makes possible a substantial improvement in the relative adhesion with a smaller decrease in the relative airtightness performance and relative adhesion performance.
Composition C-4, in accordance with the subject-matter of the invention, comprises a blend of SIBS and partially crosslinked butyl rubber with the A/B ratio of 1. A strong increase in the relative adhesion accompanied by a smaller decrease in the relative airtightness performance without a deterioration in the relative cohesion performance is recorded.

1-22. (canceled)

23. An inflatable article comprising an elastomer layer that is airtight to inflation gases used to inflate the article,
wherein the elastomer layer includes at least one blend of:
a thermoplastic elastomer that includes a polyisobutylene block, and
a partially crosslinked butyl rubber, and
wherein the thermoplastic elastomer is present in a proportion A and the partially crosslinked butyl rubber is present in a proportion B, with a ratio A/B being in a range from 1 to 20, and with A and B being expressed by weight.

24. The inflatable article according to claim 23, wherein the ratio A/B is in a range from 1 to 5.

25. The inflatable article according to claim 23, wherein a polydispersity index (PI) of the partially crosslinked butyl rubber is greater than 4.

26. The inflatable article according to claim 23, wherein a weight-average molecular weight of the partially crosslinked butyl rubber is greater than 500,000 g/mol.

27. The inflatable article according to claim 23, wherein the partially crosslinked butyl rubber is a copolymer of isobutylene and isoprene.

28. The inflatable article according to claim 23, wherein the partially crosslinked butyl rubber is a bromoisobutylene/isoprene copolymer.

29. The inflatable article according to claim 23, wherein the partially crosslinked butyl rubber is a chloroisobutylene/isoprene copolymer.

30. The inflatable article according to claim 23, wherein the partially crosslinked butyl rubber is a brominated isobutylene methylstyrene copolymer.

31. The inflatable article according to claim 23, wherein included at least one end of the polyisobutylene block of the thermoplastic elastomer is a thermoplastic block having a glass transition temperature of greater than or equal to 100° C.

32. The inflatable article according to claim 31, wherein the thermoplastic block includes at least one polymerized monomer chosen from a group that includes styrene, methylstyrenes, para-(tert-butyl)styrene, chlorostyrenes, bromostyrenes, fluorostyrenes, and para-hydroxystyrene.

33. The inflatable article according to claim 32, wherein the polyisobutylene block of the thermoplastic elastomer is chosen from a group that includes styrene/isobutylene diblock copolymers (SIBs) and styrene/isobutylene/styrene triblock copolymers (SIBSs).

34. The inflatable article according to claim 33, wherein the polyisobutylene block of the thermoplastic elastomer is a styrene/isobutylene/styrene triblock copolymer (SIBS).

35. The inflatable article according to claim 31, wherein the thermoplastic block includes at least one polymerized monomer chosen from a group that includes acenaphthylene, indene, 2-methylindene, 3-methylindene, 4-methylindene, dimethylindenes, 2-phenylindene, 3-phenylindene, 4-phenylindene, isoprene, esters of acrylic acid, crotonic acid, sorbic acid, methacrylic acid, derivatives of acrylamide, derivatives of methacrylamide, derivatives of acrylonitrile, and derivatives of methacrylonitrile.

36. The inflatable article according to claim 35, wherein a monomer of the thermoplastic block is copolymerized with a comonomer chosen from conjugated diene monomers having from 4 to 14 carbon atoms and monomers of a vinylaromatic type having from 8 to 20 carbon atoms.

37. The inflatable article according to claim 36, wherein the comonomer is styrene.

38. The inflatable article according to claim 23, wherein the elastomer layer further includes an extending oil at a content of between 5 and 150 phr, with phr corresponding to parts by weight per 100 parts of total elastomer.

39. The inflatable article according to claim 38, wherein the extending oil is a polybutene type oil.

40. The inflatable article according to claim 38, wherein the extending oil is a polyisobutylene type oil.

41. The inflatable article according to claim 23, wherein the elastomer layer further includes a platy filler at a content of between 2% and 30% by volume.

42. The inflatable article according to claim 23, wherein the inflatable article is a rubber article.

43. The inflatable article according to claim 42, wherein the rubber article is a tyre.

44. The inflatable article according to claim 42, wherein the inflatable article is an inner tube.

45. The inflatable article according to claim 44, wherein the inner tube is a tyre inner tube.
